(19) United States
(12) Patent Application Publication
(10) Pub. No.: US 2010/0003432 A1
(43) Pub. Date: Jan. 7, 2010

(54) MULTILAYER SHEET- OR TUBE-TYPE FOOD CASING OR FOOD FILM

(76) Inventor: Jürgen Schiffman, Hennef-Rott (DE)

Correspondence Address: WOLF GREENFIELD & SACKS, P.C., 600 ATLANTIC AVENUE, BOSTON, MA, 02210-2206, US

(21) Appl. No.: 12/309,997

(22) PCT Filed: Aug. 7, 2007
(86) PCT No.: PCT/EP2007/006969

§ 371 Date: Feb. 6, 2009

(30) Foreign Application Priority Data
Aug. 7, 2006 (DE) 10 2006 036 844.4

(51) Int. Cl. B32B 27/08; B32B 27/32; B32B 27/34; B32B 27/36

(52) U.S. Cl. 428/34.8; 428/476.3; 428/476.9; 428/474.7; 428/412; 428/34.9; 428/35.4; 428/35.2

(57) ABSTRACT

The present invention for the first time proposes a multilayer sheet- or tube-type food casing or food film produced by the nozzle blast-drawing process and biaxially oriented by the triple-bubble process, which is fashioned as a food packaging having the form of shrink bags, sealable films, wrapping films or the like. This novel food casing or food film comprises at least nine layers of which an EVOH layer has the form of an oxygen barrier symmetrically embedded between two PA layers intended to impart strength and in turn symmetrically enclosed by two PO layers for the water vapor barrier, and wherein the external layer is formed by a highly temperature-resistant material such as PET which on top of its excellent optical properties also enables clearly higher speeds for further processing (cycle numbers) than were previously known.

The present invention relates to a multilayer sheet- or tube-type food casing or food film which is produced by the nozzle blast-drawing process and biaxially oriented by the triple-bubble process, in particular for food packagings such as, e.g., shrink bags, sealable films, wrapping films or the like, in accordance with the preamble of claim 1.

In practice, such multilayer tube- or sheet-type packaging films are already being utilized in the form of 5- or 7-layered films.

Thus, e.g., EP 0 236 099 B2 discloses a multilayer tube-type packaging film for foodstuffs—briefly referred to as a packaging oxygen barrier film—having up to 7 layers. It is a drawback in the disclosed film that the external layer is comprised of a polyolefin (in short: PO) which does provide good protection against humidity for the inner layers but does not have a clearly enhanced temperature resistance in comparison with the inner layer (seal layer).

EP 0 476 836 B1 discusses a 6-layer packaging film which in contrast contains a temperature-resistant external layer (PET), however the core layers for oxygen barrier and mechanical strength (EVOH/PA) are not protected against humidity by a separate, pure PO layer, for neither PET nor AP (adhesion promoter) satisfy these demands to the water vapor barrier.

Moreover the EVOH layer is not sandwiched between two PA layers, thus leading to a very high tendency of curling to the outside which is additionally favored by the lacking external PO layer.

EP 1 034 076 B1 discusses a packaging film, briefly referred to as a heat-shrinkable thermoplastic multilayer film having a temperature-resistant external layer (PA). This is, however, merely an absolutely asymmetrical 5-layer structure which equally does not have any PO layer as a water vapor barrier from the outside. This in turn results in a particularly high curling tendency, accompanied by a highly impaired water vapor barrier as well as highly impaired strength, for in the absence of any protection the EVOH and the PA are exposed to humidity.

PCT/EP2004/051560, published as WO 2005/011978 A1, discloses a 5-layer packaging film having a temperature-resistant external layer (PET) and a core layer of EVOH for a good oxygen barrier. But here, too, no humidity barrier from the outside is provided. In addition it involves an entirely different manufacturing process. The disclosed films are manufactured not by the blown film process with biaxial orientation (triple-bubble process) but by the fundamentally differently designed flat tape process with biaxial orientation (tender-frame process).

DE 102 54 172 A1 and DE 102 27 580 A1 to the same applicant also disclose similar structures of 7-layered packaging films, on the one hand with PO in the external layer as a water vapor barrier, or on the other hand with PET in the external layer as a temperature-resistant layer. But an optimum solution—i.e., temperature-resistant external layer, embedding of the oxygen barrier and carrier layers (EVOH+PA) in one external and one internal humidity-repellent layers, as well as a symmetrical arrangement of the water vapor and oxygen barriers and of the carrier layers—can not be realized with only a maximum of seven available layers.

Accordingly it is an object of the present invention to further develop a generic multilayer sheet- or tube-type food casing or food film in such a way that a sufficiently tight oxygen barrier may be provided with a concurrently high water vapor barrier and with excellent mechanical strength while avoiding the above-discussed drawbacks.

It is another aspect of the invention to further develop a like multilayer sheet- or tube-type food casing or food film in such a way that excellent optical properties, good processability, high temperature resistance of the external layer and a satisfactory shrinkage ratio may moreover be ensured.

This object and these aspects are attained through the features of claim 1.

In accordance with the invention, a multilayer sheet- or tube-type food casing or food film which is produced by the nozzle blast-drawing process and biaxially oriented by the triple-bubble process, in particular for food packagings such as, e.g., shrink films, sealable films, wrapping films or the like, is being proposed which is for the first time characterized by the following layer structure for the first time including at least nine layers that are counted from the outside to the inside.

The first layer from the outside contains PET as a layer component, the second layer an adhesion promoter, the third layer a polyolefin, preferably polyethylene, the fourth layer an adhesion promoter, the fifth layer polyamide, the sixth layer an EVOH, the seventh layer polyamide, the eighth layer an adhesion promoter, and the ninth layer from the outside, which at the same time is the innermost layer, a polyolefin, preferably polyethylene.

EVOH thus advantageously furnishes the desired oxygen barrier. The PA allows to ensure the desired mechanical properties. The polyester allows to ensure excellent optical properties, such as gloss and transparency, and to obtain a high speed of further processing (cycle numbers) thanks to the high temperature resistance.

The PO allows to obtain the required water vapor barrier, and it is possible to positively influence the sealing capability of the inner layer, i.e., a high sealing bond strength may be achieved at a lowest possible sealing temperature. In the ideal case, the construction of the carrier and barrier layers (PO/PA/EVOH), designed to realize maximum symmetry, concurrently eliminates the curling tendency or in particular cases at least reduces the latter to an acceptable minimum.

The polyolefins include both PE and EVA and EM(M)A within the meaning of the present application, as well as blends of polyolefins as such and also with ionomers.

Furthermore, EVA designates both EVA and blends of EVA with polymers, ionomers, or EM(M)A. The adhesion promoters (in brief: AP) represent an adhesive layer. EVOH is to be understood both as EVOH and blends of EVOH with other polymers. Moreover PA generally represents PA as well as PA6, PA66, PA 6/66, PA 6/12 or the like, as well as blends of these and blends of PA with other polymers.

Advantageously a food casing or food film for food packagings is being furnished which alternatively allows to obtain a defined high shrinkage of up to 60% or, in contrast, a defined low shrinkage as low as 0%.

By means of the layer structures thus proposed for the first time it is advantageously possible to achieve a particularly high shrinkage for shrink bags etc., amounting to at least 20% to 60%, preferably at least 30% to 50%, measured at a water temperature of about 90° C.

By means of the layer structures thus proposed for the first time it is advantageously possible to obtain a particularly low shrinkage for sealable films etc., amounting to 0% to 30% at maximum, preferably 2% to 5%, measured at a water temperature of about 90° C.

By means of the layer structures thus proposed for the first time it is advantageously possible to obtain a particularly low shrinkage for wrapping films etc., amounting to 0% to 5% at maximum, preferably 0% to 2%, measured at a water temperature of about 90° C.

With the layer structures thus proposed for the first time it is advantageously possible to provide, for example, a polyolefin, preferably with LDPE, LLDPE, EVA, EM(M)A, ionomers or POP or blends thereof etc., as a starting material for the seal layers that are to be provided on the inside of shrink bags or sealable films and wrapping films, respectively.

The particularly pronounced oxygen barrier obtained as a result of the layer component EVOH ensures excellent preservation over several weeks without any quality decrease of the foods thereby packaged.

Thanks to the extremely well-formed oxygen barrier, the food casing or food film of the invention for the first time furnishes a food packaging whereby even goods that are particularly sensitive to air are not subject to color changes or even to the risk of ageing or changing their taste or aroma due to the entry of oxygen, even over long storage periods.

Thus, in a a preferred layer structure the layer component EVOH is embedded sandwich-style between two layers including polyamide as a layer component, which leads to a maximum possible oxygen barrier and at the same time ensures excellent embedding and stabilization of the EVOH layer between the two polyamide layers as carrier layers.

As the barrier properties of EVOH and also of PA may be influenced negatively by humidity, a sandwich-type layer structure, i.e., embedding of the EVOH and PA layers between two polyolefin layers as a water vapor barrier from the inside and from the outside, is also preferred here.

Hereby an excellent water vapor barrier is made available, which is crucial particularly in the case of meats or other foods that need to be kept fresh. Foodstuffs packaged with the food casing or food film of the invention thus stay fresh for a particularly long time.

Owing to the low water vapor permeability, the weight losses involved in storing the foods and particularly in storing meats remain particularly low.

The outermost layer of the food casing or food film thus proposed for the first time consists of high temperature-resistant starting materials such as PET and therefore admits the possibility of welding the films by extremely high temperatures without the film being bonded to the welder terminal. As a result, higher cycle numbers may be achieved on the welding machines. In addition the film is substantially less sensitive to external injury and possesses—as is customary for PET—excellent optical properties in regard of gloss and transparency. Furthermore the film is particularly well suited for inscribing or printing.

In addition, the food casing or food film of the invention may be manufactured and processed particularly well with the aid of corresponding facilities by the same applicant.

Advantageous aspects or developments of the invention result from the features of the appended claims.

Thus, in a preferred embodiment of the food casing or food film for food packagings in accordance with the invention it is provided that layers which contain polyethylene as a layer component alternatively also contain polypropylene, EVA (Ethyl Vinyl Alcohol), EM(M)A, ionomers, or blends of these, or the like.

In a preferred embodiment it is moreover provided that layers which contain an adhesion promoter optionally include an adhesion promoter on the basis of PE, EVA, EM(M)A or of an ionomer as a base material.

In accordance with a further preferred embodiment it is provided that layers which include an adhesion promoter as a component alternatively contain a blend of polyolefin and adhesion promoter or a blend of EVA and/or EM(M)A and adhesion promoter.

In accordance with a further preferred embodiment it is provided that layers which include EVOH as a layer component alternatively contain MXD6 (modified polyamide).

In a further preferred embodiment it is provided that layers which include EVOH as a component alternatively contain PVA.

In accordance with a further preferred embodiment of the food casing or food film of the invention it is provided that layers which include polyamide as a layer component alternatively contain an ionomer.

In accordance with a preferred embodiment it is furthermore provided that layers which include polyamide as a layer component alternatively contain MXD6.

Not last it is provided in accordance with a preferred embodiment that layers which include polyamide as a layer component contain polycaprolactame (PA6), polyhexamethylene adipinamide (PA66), PA 6/66, PA 11, PA 12, or blends of these polyamides or the like.

Equally preferred is another embodiment wherein layers which include polyamide as a component alternatively contain blends of PA and EVOH, or PA and PVA or PA and MXD6, respectively.

In accordance with a further preferred embodiment it is provided that layers which contain EVOH or PVA or MXD6, respectively, alternatively include blends of these starting materials with PA.

Another preferred embodiment provides that the external PO layer (3^{rd} layer from the outside) alternatively contains a COC or a blend of a polyolefin and a COC.

Further preferred embodiments provide that the external layer which contains PET alternatively includes PA, MXD6, PS, PMMA, or PC.

In addition, further preferred embodiments provide that the external layer which contains PET alternatively includes COC, PP, or HDPE or blends of these starting materials with polyolefin, respectively.

In a further preferred embodiment, the food casing or food film of the invention is realized as a food packaging having the form of a shrink bag, a sealable film, a wrapping film, or the like.

The present invention thus for the first time proposes a sheet- or tube-type food casing or food film having a layer structure with at least nine layers, which possesses for an oxygen barrier an EVOH layer symmetrically embedded between two PA layers intended to impart strength and in turn symmetrically enclosed by two PO layers for the water vapor barrier, and wherein the external layer is formed by a high-temperature-resistant material such as PET which on top of its excellent optical properties also enables clearly higher speeds for further processing (cycle numbers) than were previously known.

1. A multilayer sheet- or tube-type food casing or food film which is produced by the nozzle blast-drawing process and biaxially oriented by the triple-bubble process, in particular for food packagings, characterized by the following layer structure including at least nine layers that are counted from the outside to the inside, wherein:
a first layer from the outside contains PET as a layer component,
a second layer contains an adhesion promoter as a layer component,
a third layer contains a polyolefin, preferably polyethylene, as a layer component,
a fourth layer contains adhesion promoter as a layer component,
a fifth layer contains polyamide as a layer component,
a sixth layer contains EVOH as a layer component,
a seventh layer contains polyamide as a layer component,
an eighth layer contains adhesion promoter as a layer component, and
a ninth layer contains a polyolefin, preferably polyethylene, as a layer component.

2. The food casing or food film according to claim 1, characterized in that layers which contain a polyolefin, preferably polyethylene, as a layer component alternatively also contain further polyolefins, polypropylene, EVA, EM(M)A, ionomers or blends of these, or the like.

3. The food casing or food film according to any one of claims 1 or 2, characterized in that layers which contain an adhesion promoter include an adhesion promoter on the basis of PE, PP, EVA, EM(M)A or of an ionomer as a base material.

4. The food casing or food film according to any one of claims 1 to 3, characterized in that layers which include an adhesion promoter alternatively contain a blend of polyolefin and adhesion promoter or a blend of EVA and/or EM(M)A and adhesion promoter or ionomer and adhesion promoter, or various adhesion promoters or blends thereof, respectively, in the single layers.

5. The food casing or food film according to any one of claims 1 to 4, characterized in that layers which include EVOH as a layer component alternatively contain MXD6 (modified polyamide 6).

6. The food casing or food film according to any one of claims 1 to 5, characterized in that layers which include EVOH as a layer component alternatively contain PVA (polyvinyl alcohol).

7. The food casing or food film according to any one of claims 1 to 6, characterized in that layers which include polyamide as a layer component alternatively contain polycaprolactame (PA6), polyhexamethylene adipinamide (PA66), PA6/66, PA 11, PA12, or blends of these polyamides or the like.

8. The food casing or food film according to any one of claims 1 to 7, characterized in that layers which include polyamide as a layer component alternatively contain MXD6.

9. The food casing or food film according to any one of claims 1 to 8, characterized in that layers which include polyamide as a layer component alternatively contain an ionomer.

10. The food casing or food film according to any one of claims 1 to 9, characterized in that layers which include polyamide as a layer component alternatively contain blends of PA and EVOH, or PA and PVA or PA and MXD6, respectively.

11. The food casing or food film according to any one of claims 1 to 10, characterized in that the layers which include EVOH or PVA or MXD6, respectively, alternatively contain blends of these starting materials with PA.

12. The food casing or food film according to claim 1, characterized in that the third layer from the outside alternatively contains a COC or a blend of COC and a polyolefin as a layer component.

13. The food casing or food film according to any one of claims 1 to 12, characterized in that layers which include PET as a layer component alternatively contain polycaprolactame (PA6), polyhexamethylene adipinamide (PA66), PA6/66, PA11, PA12, or blends of these polyamides or the like.

14. The food casing or food film according to any one of claims 1 to 13, characterized in that layers which include PET as a layer component alternatively contain PS (polystyrene).

15. The food casing or food film according to any one of claims 1 to 14, characterized in that layers which include PET as a layer component alternatively contain COC or a blend of COC and a polyolefin.

16. The food casing or food film according to any one of claims 1 to 15, characterized in that layers which include PET as a layer component alternatively contain a polyolefin, preferably PP or HDPE or blends of different polyolefins.

17. The food casing or food film according to any one of claims 1 to 16, characterized in that layers which include PET as a layer component alternatively contain PC (polycarbonate).

18. The food casing or food film according to any one of claims 1 to 17, characterized in that layers which include PET as a layer component alternatively contain PMMA.

19. The food casing or food film according to any one of claims 1 to 18, characterized in that layers which include PET as a layer component alternatively contain MXD6.

20. The food casing or food film according to any one of claims 1 to 19, characterized in that it is fashioned as a food packaging having the form of a shrink bag, a sealable film, or a wrapping film.
